(19) United States
(12) Patent Application Publication
(10) Pub. No.: US 2004/0104853 A1
(43) Pub. Date: Jun. 3, 2004

(54) Flat and leveled F antenna

(76) Inventor: Po-Chao Chen, Taipei (TW)

Correspondence Address: BIRCH STEWART KOLASCH & BIRCH, PO BOX 747, FALLS CHURCH, VA, 22040-0747, US

(21) Appl. No.: 10/307,368

(22) Filed: Dec. 2, 2002

(51) Int. Cl. H01Q 1/24

(52) U.S. Cl. 343/702; 343/700 MS

(57) ABSTRACT

A flat and leveled F antenna formed on a printed circuit board to be adopted on a notebook computer or a portable electronic device with a limited space has an open end on the bi-frequency or tri-frequency antenna with calculated resonate lengths of different frequencies to support multi-frequency antennae. The equivalent length from the open end and the signal feed end is ¼ of the wavelength of the waves to be emitted by the antenna. Antennae of different frequencies have different resonant lengths. The working frequency spectrum of the antenna can be adjusted by altering the shape of the open end.

### FIELD OF THE INVENTION

The invention relates to an antenna, and particularly to a bi-frequency flat and leveled F antenna for use on notebook computers or portable electronic devices.

### BACKGROUND OF THE INVENTION

Miniaturization is a prevailing contemporary trend for the design of communication products. For instance, the size of mobile phones has been constantly reduced in recent years. In addition, more and more communication products are integrated with other electronic products, such as notebook computers or personal digital assistants (PDAs) equipped with communication features. To install these additional features onelectronic products, they must be miniaturized. For products to conform to widely accepted protocols such as Blue Tooth and Wireless LAN, integrating communication features with electronic products is an unavoidable direction, and product miniaturization has become critical.

In developments of communication technologies, the antenna is an important factor should be taken into account. With the size of communication devices being constantly reduced, the antenna also has to be reduced. Many techniques have been developed in the prior art to address this issue, such as the micro strip antenna (thin antenna), leveled F antenna, antenna with high dielectric constant, antenna wedged in a crevice, small size helical antenna and the like.

In addition, in order to expand the broadband, the range of frequency for the communication devices has also increased. The current trend is moving to even higher frequencies. With Blue Tooth for example, the base frequency is 2.4 GHz. With GSM it is 1.8 GHz, and wireless LAN is 2.4 GHz (802.11b) and 5.2 GHz (802.11a). With such high frequencies, the antenna must be miniaturized.

Moreover, in response to the wide applications of the frequency, there is an increasing demand to make one communication device to support two or more frequencies. Various solutions have been developed and introduced to meet this requirement. To make the miniaturized antenna support two or more working frequencies has also become a hot R & D issue.

Portable electronic devices such as notebook computers have many metal structures that form a shield against electromagnetic interference (EMI). They also reflect radiation of the antenna. Hence many factors have to be considered in the design of a built-in antenna for notebook computers. This is a challenge that does not exist for the design of free space antennae. As frequency, characteristics, and field are changeable, the design of bi-frequency or multi-frequency built-in antennae for notebook computers is much more difficult.

### SUMMARY OF THE INVENTION

In view of the aforesaid problems with the conventional techniques, the object of the invention is to provide a flat and leveled F antenna that may be adopted on a screen edge of notebook computers or an edge of a metal surface of electronic devices, and to support bi-frequency or multi-frequency according to requirements.

In order to achieve the foregoing object, the invention provides a bi-frequency flat and leveled F antenna laid on the LCD panel of a notebook computer for radio receiving and transmission. It is formed on a printed circuit board and includes a feed end, a short end, a ground end and two radiation elements. The feed end is connected to the signal source of a cable line to receive voltage signals. The short end is connected to the ground of the cable line and the ground. The two radiation elements each have an open end with a path length designed based on the frequency of the two voltage signals and stretched between the feed end and the open end to radiate and receive electromagnetic waves of different frequencies.

Moreover, the invention also provides a tri-frequency flat and leveled F antenna that adopts the same design principle to make the tri-frequency flat and leveled F antenna available for use with notebook computers.

Increasing the area of the tail end of the open end will increase the bandwidth of the antenna. The design is suitable for both bi-frequency and tri-frequency.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 a schematic view of a flat and leveled F antenna of the invention

FIG. 2 is a schematic view of a first embodiment of the invention for a bi-frequency flat and leveled F antenna.

FIG. 3 is a schematic view of a second embodiment of the invention for a bi-frequency flat and leveled F antenna.

FIG. 4 is a schematic view of a first embodiment of the invention for a tri-frequency flat and leveled F antenna.

FIG. 5 is a schematic view of a second embodiment of the invention for a tri-frequency flat and leveled F antenna.

FIG. 6 is a schematic view of a third embodiment of the invention for a tri-frequency flat and leveled F antenna.

### DESCRIPTION OF THE PREFERRED EMBODIMENTS

In order to equip a portable electronic device such as a notebook computer with a built-in antenna to support bi-frequency or more, the antenna of the invention adopts a leveled F design.

As there is space constraint in the notebook computer for housing a built-in antenna, the dimension of the antenna is restricted. Considerations of radiation field and directivity must be included in the design of the antenna. As slim and light has become the trend of notebook computer design, the location for housing the built-in antenna is restricted to a small area on the border of the LCD panel. The printed circuit board is a desired means to support the flat and leveled F antenna. Fabrication is relatively simple.

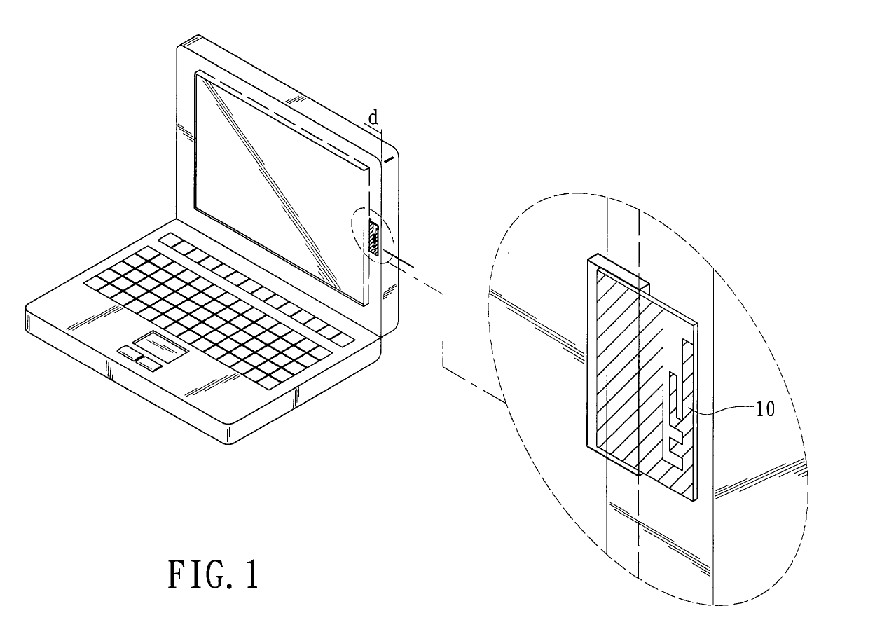

Referring to FIG. 1, on a notebook computer (NB) there is a gap of distance d between the LCD panel and the casing. The gap may be used for forming the bi-frequency flat and leveled F antenna 10 of the invention. The bi-frequency flat and leveled F antenna 10 includes a ground connecting directly to the ground section of the LCD panel, and the distance d is reserved for the leveled F antenna body for radiating outwards. As there is a space constraint in the design of the bi-frequency flat and leveled F antenna 10, the distance d is the basis of the dimension for the design of the antenna.

Details of the flat and leveled F antenna of the invention are discussed below with reference to the accompanying embodiments.

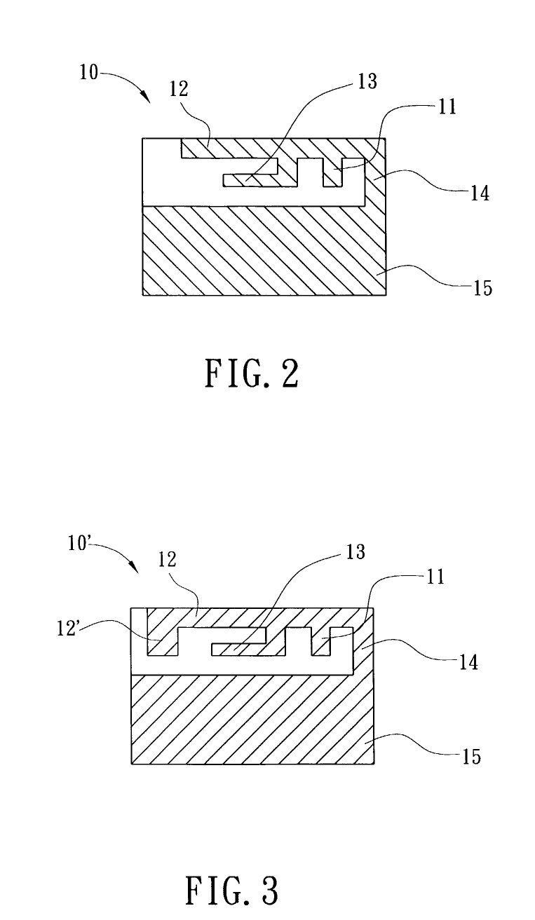

Refer to FIG. 2 for a first embodiment of the invention. It is based on an elongated space bordering the LCD panel of an NB and is set for bi-frequency of 2.4 G and 5.2 G. The bi-frequency flat and leveled F antenna 10 includes a feed end 11, a first open end 12, a second open end 13, a short end 14 and a ground section 15. The feed end 11 is the connection point of a signal line for establishing electric connection with the signal line. Through signal input on the signal line, high frequency signal (voltage) may be transmitted from the feed end 11 to the first open end 12 and the second open end 13, and also generates radiation.

In terms of design, in the antenna of the first embodiment, the radiation path from the feed end 11 to the tail end of the first open end 12 conforms to ¼ wavelength (12.5 cm) of 2.4 GHz, i.e. about 3-4 cm. The radiation path from the feed end 11 to the tail end of the second open end 13 conforms to ¼ wavelength (5.8 cm) of 5.2 GHz, i.e. about 1.5-2 cm. However, the equivalent resonant length layer changes with alterations of space size, case material, and thickness. Hence the antenna requires some fine tuning to respond to different environments. Thus, when a voltage of a corresponding frequency is input from the signal line to the feed end 11, a voltage proximate to 2.4 GHz may radiate through the first open end 12, or a voltage proximate to 5.2 GHz may radiate through the second open end 13. On the other hand, when receiving an electromagnetic wave of the same frequency, the corresponding electromagnetic waves are received through the first open end 12 or the second open end 13 in the reverse direction and are induced to voltage for input, and are then transmitted to the signal line.

In addition, in order to increase the bandwidth of the antenna, the open end may be designed wider to increase the range of resonant frequency on the open end. As shown in FIG. 3, the open portion of the first open end 12 of the bi-frequency flat and leveled F antenna 10′ has a greater width to increase the bandwidth.

As previously discussed, the second open end 13 may also be made wider to increase the bandwidth of the high frequency portion for the embodiments shown in FIGS. 2 and 3.

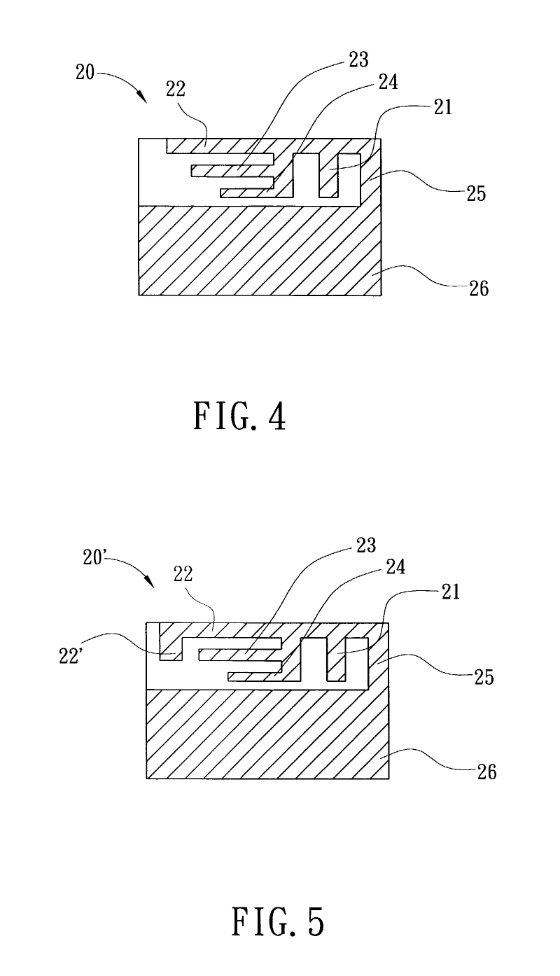

It is concluded that by configuring the path between the feed end and the open end of the flat and leveled F antenna, a bi-frequency flat and leveled F antenna may be made. Similarly, other multi-frequency flat and leveled F antennae may be made by adopting a similar design. FIG. 4 illustrates an embodiment of a multi-frequency flat and leveled F antenna that has three opening ends to achieve three radiation frequencies.

The ti-frequency flat and leveled F antenna mentioned above includes: a feed end 21, a first open end 22, a second open end 23, a third open end 24, a short end 25 and a ground section 26. The feed end 12 is the connection point of the signal line. High frequency signals are transmitted from the feed end 21 to the first open end 22, the second open end 23, and the third open end 24 for radiating.

In terms of design, in the antenna of the second embodiment, the distance of the open path from the first open end 22 to the feed end 21 conforms to ¼ wavelength of 1.8 GHz (16.6 cm), i.e. about 4-5 cm. The distance of the open path from the second open end 23 to the feed end 21 conforms to ¼ wavelength (12.5 cm) of 2.4 GHz, i.e. about 3-4 cm. The distance of the open path from the third open end 24 to the feed end 21 conforms to ¼ wavelength (5.8 cm) of 5.2 GHz, i.e. about 1.5-2 cm. Thus when a voltage of a corresponding frequency is input from the feed end 11, 1.8 GHz may be radiated through the first open end 22, 2.4 GHz voltage may be radiated through the second open end 23, and 5.2 GHz voltage may be radiated through the third open end 24. On the other hand, when receiving electromagnetic waves of the same frequency, the electromagnetic waves of corresponding frequencies are received through the first open end 22, the second open end 23 or the third open end 24 in the reverse direction and are induced to voltage for input.

Similarly, in order to increase the frequency spectrum of the antenna, the open end may be designed wider to increase the range of resonant frequency on the open end. As shown in FIG. 5, the tail end portion of the first open end 22 has a greater width to increase the frequency spectrum.

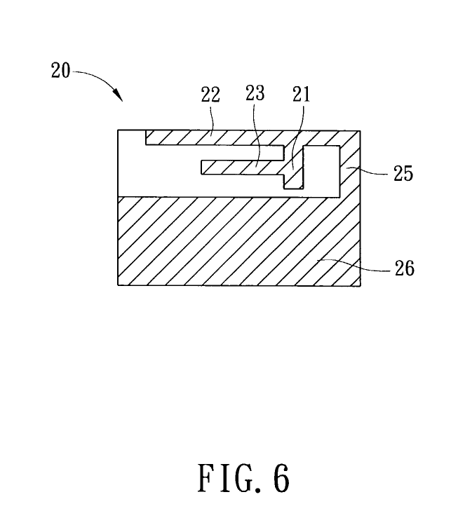

Moreover, the selected frequency may be 0.9 GHz, 1.6 GHz, 1.8 GHz, 2.0 GHz, 2.4 GHz, and 5.2 GHz, or the like. The flat and leveled F antenna may then be designed according to the required radiation length. FIG. 6 also illustrates the same concept.

In summary, the flat and leveled F antenna of the invention may be installed on the LCD panel of a notebook computer to become a hidden antenna to achieve a bi-frequency or multi-frequency effect in the limited space of the notebook computer.

While the preferred embodiments of the inventions have been set forth for purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A bi-frequency flat and leveled F antenna formed on a circuit board for a notebook computer for radio receiving and transmitting and located flatly on a liquid crystal display (LCD) panel of the notebook computer, comprising:
a feed end connecting to a signal line for feeding two voltage signals;
a ground section connecting electrically to a ground of the LCD panel;
a short end connecting to the ground section for outputting the two voltage signals to the ground section; and
two radiation paths, each of the two radiation paths having an open end, wherein the lengths of the paths are based on the frequencies of the two voltage signals and are stretched from the feed end to the two open ends to radiate respectively the two voltage signals corresponding to the two radiation paths and receiving two electromagnetic waves of corresponding frequencies transmitted from outside, the two voltage signals being transmitted back to the ground section through the short end.

2. The bi-frequency flat and leveled F antenna of claim 1, wherein the lengths of the two radiation paths are adjustable to modulate the resonant frequencies thereof.

3. The bi-frequency flat and leveled F antenna of claim 1, wherein the sizes of the two radiation paths are adjustable to increase the bandwidth thereof.

4. The bi-frequency flat and leveled F antenna of claim 1, wherein the frequencies of the two voltage signals are selected from two the group consisting of 0.9 GHz, 1.6 GHz, 1.8 GHz, 2.0 GHz, 2.4 GHz, and 5.2 GHz.

5. A tri-frequency flat and leveled F antenna formed on a circuit board for a notebook computer for radio receiving and transmitting and located flatly on a liquid crystal display (LCD) panel of the notebook computer, comprising:
a feed end connecting to a signal line for feeding three voltage signals;
a ground section connecting electrically to a ground of the LCD panel;
a short end connecting to the ground section; and
three radiation paths, each of the two radiation paths having an open end, wherein the lengths of the paths are designed based on the frequencies of the three voltage signals and are stretched from the feed end to the three open ends to radiate respectively the three voltage signals corresponding to the three radiation paths and receiving three electromagnetic waves of corresponding frequencies transmitted from outside.

6. The tri-frequency flat and leveled F antenna of claim 5, wherein the lengths of the three radiation paths are adjustable to modulate the resonant frequencies thereof.

7. The tri-frequency flat and leveled F antenna of claim 5, wherein the sizes of the three radiation paths are adjustable to increase the bandwidth thereof.

8. The tri-frequency flat and leveled F antenna of claim 5, wherein the frequencies of the three voltage signals are selected from three of the group consisting of 0.9 GHz, 1.6 GHz, 1.8 GHz, 2.0 GHz, 2.4 GHz, and 5.2 GHz.
